(19) United States
(12) Patent Application Publication
(10) Pub. No.: US 2010/0212373 A1
(43) Pub. Date: Aug. 26, 2010

(54) Electronic door lock apparatus

(75) Inventor: Thomas J. Wheeler, Pomona, CA (US)

Correspondence Address: WILLIAM W. HAEFLIGER, 201 S. LAKE AVE, SUITE 512, PASADENA, CA, 91101, US

(73) Assignee: ADAMS RITE MANUFACTURING CO.

(21) Appl. No.: 12/658,425

(22) Filed: Feb. 10, 2010

Related U.S. Application Data
(60) Provisional application No. 61/208,680, filed on Feb. 25, 2009.

(51) Int. Cl. E05B 47/00; E05B 65/00; G05B 11/00

(52) U.S. Cl. 70/91; 700/275

(57) ABSTRACT

Door lock apparatus, comprising in combination an elongated housing having input code selectors on the housing, to enable door locking and/or unlocking via a locking element, a locking handle protruding from the housing, a coupling in the housing having parts that interfit to enable force transmission between said handle and element, and first means responsive to code selection to control coupling of the parts.

### BACKGROUND OF THE INVENTION

This application claims priority from provisional application Ser. No. 61/208,680, filed Feb. 25, 2009.

This invention relates generally to electronically or electronically controlled locks, such as door locks. More particularly, it concerns improvements in control mechanisms located between handle input, and latch or bolt outputs of such devices.

There is need for simplicity, reliability, and effectiveness of such control mechanisms, including improvements in structure, functioning and results associated with operation of such mechanisms.

### SUMMARY OF THE INVENTION

It is a major object of the invention to provide improvements meeting the above needs. Basically, the invention is embodied in the following, in combination:
a) an elongated housing having input code selectors on the housing, to enable door locking and/or unlocking via a locking element,
b) a locking handle protruding from the housing,
c) a coupling in the housing having parts that interfit to enable force transmission between said handle and element,
d) and first means responsive to code selection to control coupling of said parts.

As will be seen, said means include an electronic motor in the housing to effect controlled displacement of one or more of said parts.

Another object include provision of second means to compensate for interfit misalignment of said parts and to automatically overcome said misalignment.

That second means may advantageously include a spring or springs biasing at least one of said parts to interfit another of said parts in response to relative rotation of said parts.

Another object is to provide means to resist handle turning at selected handle turn angles, and also allow handle turning in response to override force transmitted via handle turning, for handle re-positioning relative to the housing.

A further object include provision of handle force resisting structure that includes a rotor, an elongated spring, and at least one set of interengaged balls that transmit spring force to the rotor with mechanical advantage.

Yet another object is to provide coupling parts, and a spring or springs biasing at least one of said parts to interfit another of said parts in response to relative rotation of said parts. One of such springs may be compliant fork-shaped leaf spring urging the coupling against tips of the pins.

A further object is to provide means to compensate and overcome misalignment of coupling pins and slots in a coupler.

An additional object is to provide means to allow release of a battery cover, including a one-piece elongated shifter basically movable in response to key input turning of a control rotor.

Also, the housing may include a battery compartment lid, there being a retention fastener, an override bracket blocking access to the fastener from the exterior, and having a position in which such access is unblocked, there being means blocking movement of the bracket to said position in response to unauthorized such access.

An additional object is to provide apparatus multiple improvements as disclosed herein.

These and other objects and advantages of the invention, as well as the details of an illustrative embodiment, will be more fully understood from the following specification and drawings, in which:

### DRAWING DESCRIPTION

FIG. 1 is a perspective view of lock apparatus incorporating the invention;

FIG. 2 is a diagram showing a system of elements carried within the apparatus housing, to effect operation of the lock in response to handle turning;

FIG. 3 is a perspective view of a handle re-positioning clutch mechanism;

FIG. 4 is an axial section taken through FIG. 3;

FIG. 5 is a view like FIG. 1, but with the handle turned to show length direction, the same as housing length;

FIGS. 6-8 show coupling mechanisms;

FIG. 9 shows a configuration of motion translation elements between the coupling and the latch or dead bolt;

FIG. 10 is a view like FIG. 9, but showing shifted position of elements;

FIG. 11 is a side view showing installation of an override bracket for blocking access to a fastener that secures a battery compartment lid;

FIG. 12 is a frontal view of FIG. 11 elements;

FIG. 13 is a perspective view of the override bracket;

FIG. 14 is a perspective view of the battery compartment lid;

FIG. 15 is a perspective view of a sensor plate.

FIG. 16 shows Hall Effect mechanism;

FIG. 17 is a schematic view of override bracket and compliant spring positioning.

### DETAILED DESCRIPTION

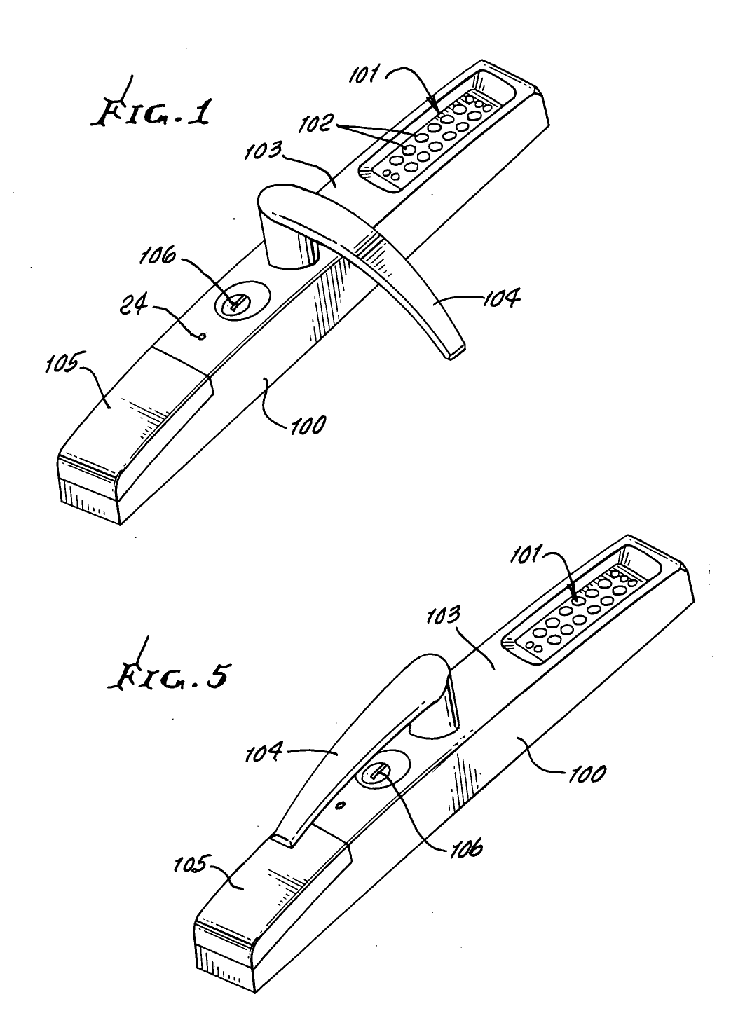

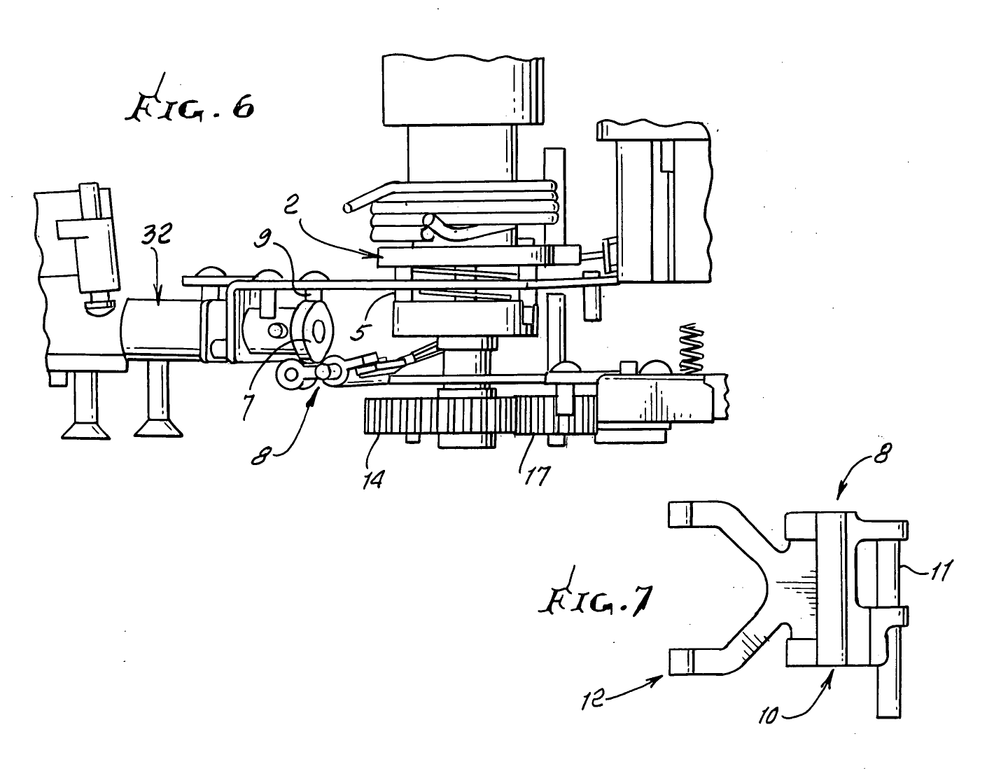

Referring first to FIG. 1, it shows the lock assembly in the form of an elongated housing, 100 with a key pad 101 including multiple coding selectors at 102 on the housing outer side 103. A handle 104 is carried for turning as between FIG. 1 and FIG. 5 positions. Batteries within the housing are accessible after removal of lid or cover plate 105, in response to insertion of a key into the housing via slot 106 and turning of the key, which releases the plate.

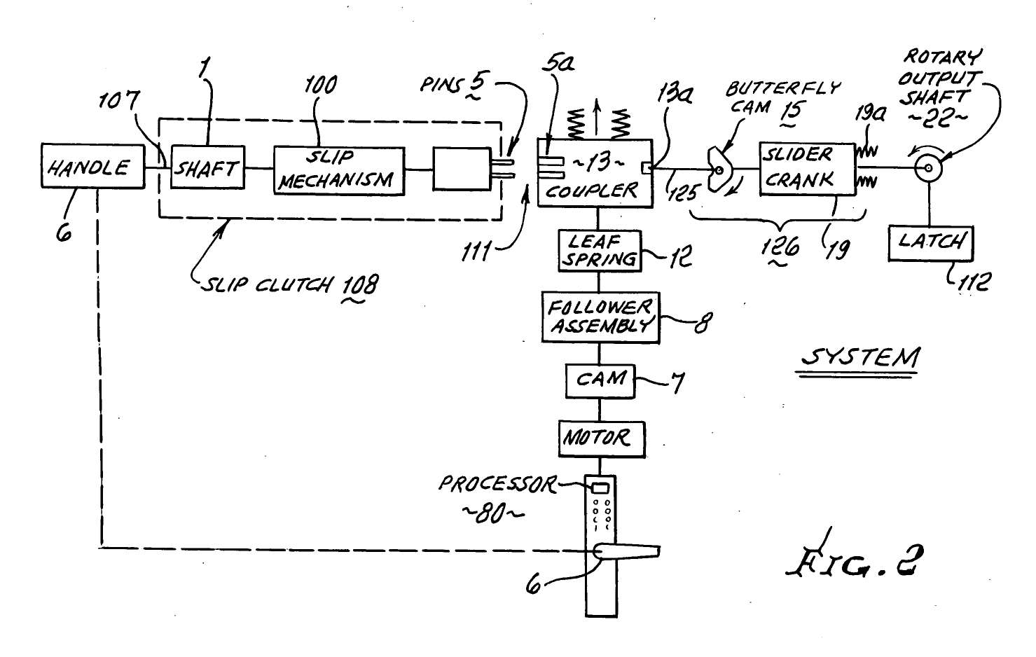

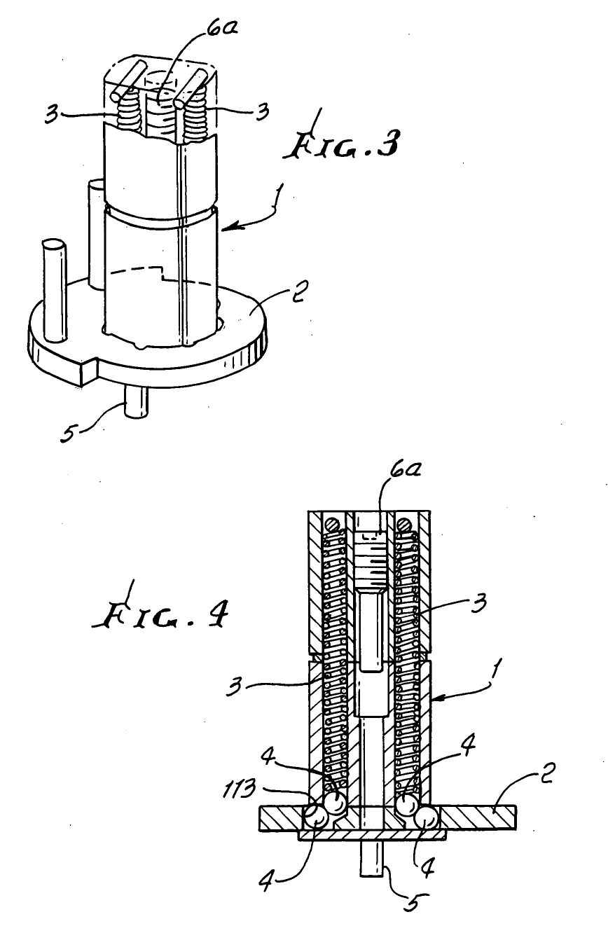

Referring to the system schematic diagram seen in FIG. 2, it shows handle input displacement, such as turning, at 107, to a slip clutch 108 assembly. The assembly shown includes a shaft 1 mechanism 110 allowing handle slip, and output pins 5. Referring to the FIG. 3 description of the clutch assembly, it includes a clutch plate 2, two compression springs 3, four steel balls 4, two coupling 5, an override set screw 6a, and various other pins. The handle connects to the output shaft 1. A coupling mechanism 111 (see FIG. 2) couples the coupling pins 5 to the drive mechanism of the unit that finally drives the deadbolt or dead latch device. A latch device is shown at 112 in FIG. 2. The slip clutching mechanism 108 seen in FIG. 2 is designed to allow slippage of the handle relative to the unit mechanism at a torque lower than would be required to destroy or damage the unit mechanism but at a torque significantly higher than normally required to operate a latch or deadbolt device. In such capacity, the clutching mechanism acts as a mechanical “fuse” if for instance the deadbolt is “jammed” or misaligned with its mating strike plate. The clutch plate 2 has ball detent pockets every 45 degrees, about the axis of plate rotation. The output shaft 1 has a plurality (two, as shown) of vertical holes drilled to house long compression springs 3. These holes are intersected by perpendicular holes at the bottom of the output shaft 1 radiating out from output shaft 1 centerline or axis. The compression springs push downwards against steel balls oriented to push outwards against a second set of steel balls at a shallow pressure angle. The second set of steel balls protrude out of the perpendicular holes in the output shaft 1 and engage detent pockets 113 in the clutch plate 2. In this way, the orientation of the balls relative to their mating balls allow the springs to be located in perpendicular relation to the necessary direction of final force application for the clutch and situated in an orientation where more space is available. Note that the direction of spring elongation is parallel to the length direction of the housing 100. Furthermore, the shallow pressure angle and friction between the ball pairs creates a mechanical advantage that allows a lower spring force to create a higher clutching torque. This allows the mechanism to be more compact and lower cost than would otherwise be feasible. FIG. 4 shows a section view of the clutching mechanism.

Besides acting as a mechanical fuse, the orientation, lengthwise of the housing clutching mechanism provides other benefits. With the battery lid 105 removed, the handle can be rotated to a detent position 90 degrees from the normal operating position of the handle as shown in FIG. 5. This allows the unit to be shipped in a compact configuration with the handle already attached. This in turn minimizes packaging size/cost and freight charges.

Furthermore, the clutching mechanism allows the unit to be “rehanded” in the field, quickly and easily. For instance, some applications require the handle to point right and others require that it point left. When the unit is removed from packaging, the handle can be rotated two detent positions clockwise if the handle heeds to point left or two detent positions CC to point right. The unit can be “rehanded” any time in the field if there is a desire to remount the unit in a different location requiring opposite handling.

Coupling mechanism is provided to couple the handle to drive mechanism, as via the slip clutch 108. See for example in FIG. 2, coupler 120 receiving input via pins 5 of the slip clutch 108, and transmitting rotary drive at 125 to drive mechanism 126. Such mechanism effects such coupling in response to operation of an electrical motor 127 controlled by the selectors 102 of the keypad 101 control. In this regard, means is provided to compensate for input misalignment of the coupling parts (typically pins 5 and slots 5a in the coupler, such misalignment typically being rotary), and to automatically overcome such misalignment to enable effective coupling, for operation of the latch by the handle.

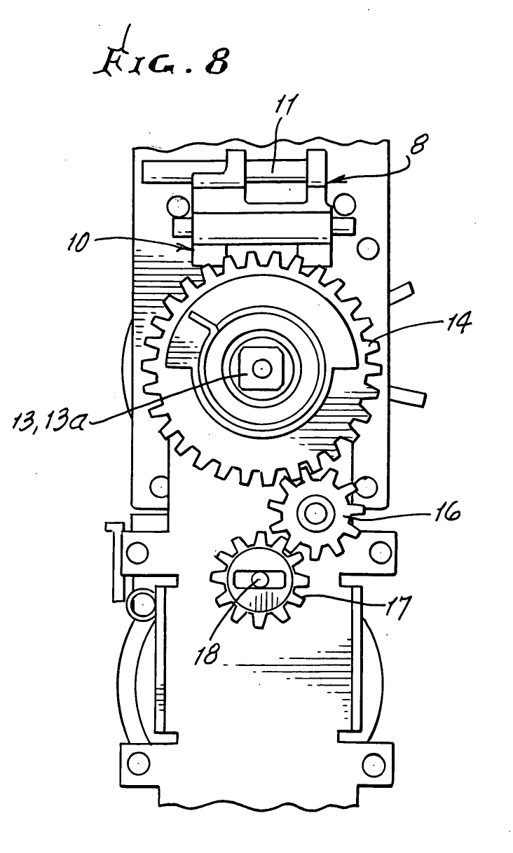

As shown in FIGS. 6-8, a keypad operated gear motor 6 drives a cam 7 that pushes on a cam follower assembly 8. The cam follower assembly 8 pivots around a mounting pin 9. The cam 7 follower assembly 8 consists of a body 10, a cam follower pin 11, and a fork shaped leaf spring 12. The fork shaped leaf spring 12 pushes against a coupler 13 that is biased against the fork shaped leaf spring 12 with a light compression spring 12a. The spring constant and preload of the leaf spring 12 is significantly higher than that of the compression spring. When the high side lobe of the cam 7 pushes down against the cam follower pin 11, the cam follower assembly 8 pivots around the pin 9. The fork shaped leaf spring 12 pushes against the coupler 13 causing it to move upwards until the coupling pins 5 engage slots 5a in the coupler 13. With the handle in its rest position 3 or 9 O'clock, the coupler pins 5 are aligned with slots 5a in the coupler 13 and the fork shaped leaf spring 12 only has to deflect a minute amount to compress the compression spring biasing the coupler 13 downwards. If for instance a user has the handle turned while operating the coupler and the coupler pins 5 do not align with the slots in the coupler 13, the fork shaped leaf spring 12 bends more and pushes the coupler 13 against the tips of the coupler pins 5. Once the handle has released to the 3 or 9 O'clock position, the force from the fork shaped leaf spring 12 will push the coupler pins 5 into the coupler 13 slots 5a. Thus, the fork shaped leaf spring 12 provides enough rigidity to overcome the compression spring but enough compliance so the mechanism does not lock up or stall with the handle moved out of normal position.

In the event that the unit's batteries die at a position where the lock is left in an unlocked position, the unit handle can be removed and the override set screw 6 tightened until the coupler 13 is no longer engaged to the coupler pins 5. Thus the unit is returned to a locked position. The compliance of the fork shaped leaf spring 12 allows this to happen without permanent damage to the unit. When the batteries are replaced the override set screw 6 can be backed off to allow normal operation.

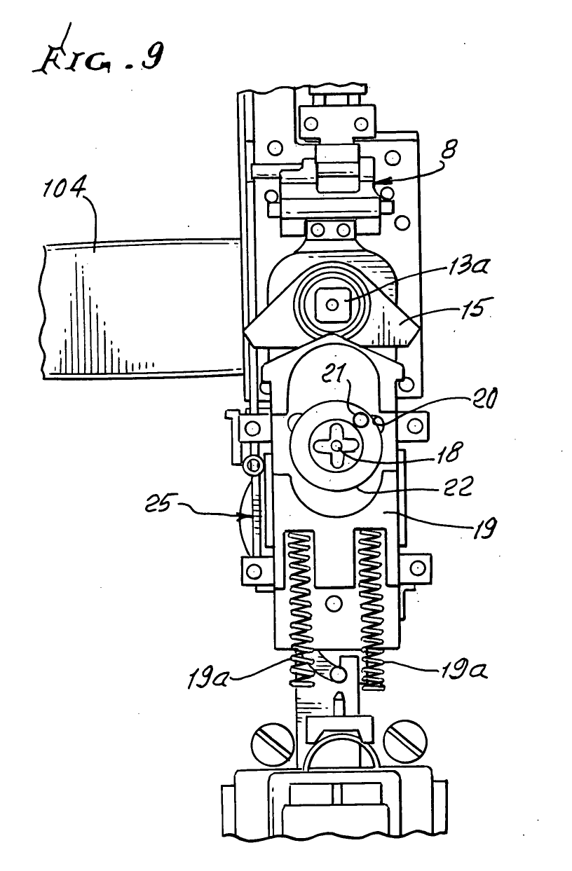

Referring to FIGS. 8 and 9, the coupler 13 has a square shaped shaft 13a that keys either to an input gear 14 or to a butterfly shaped cam 15 depending on whether the unit will operate a deadbolt or dead latch, respectively. The square feature of the shaft 13a allows it to translate up and down and also transmit torque through its entire range of motion.

The alternative deadbolt mechanism consists of three gears, an input gear 14, an idler gear 16, and an output gear 17. The output gear 17 has a rectangular opening that accepts a sheet metal “tailpiece”. The “tailpiece” couples the output gear 17 to the deadbolt device. A small magnet 18 holds the tailpiece in place while the unit is being assembled to the door.

Typically, deadbolts require two directions of output to operate the bolt. One direction of rotation locks the deadbolt while the opposite direction of rotation unlocks the deadbolt. The illustrated gear train mechanism provides two directions of output rotation for two directions of handle rotation.

The required direction can be clockwise or counterclockwise depending on whether door lock is right or left handed. Therefore, the dead latch version needs to be able to rotate either direction, but only one direction at a time.

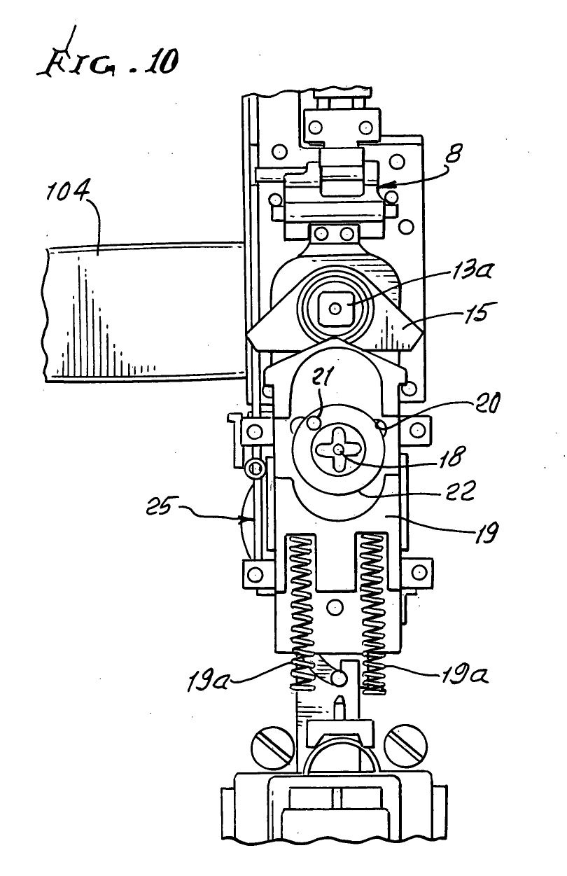

Referring to FIG. 9, the butterfly shaped cam 15 keys to the coupler 13. The butterfly shaped cam 15 interacts with a slider crank 19. The slider crank is biased to the left by two compression springs 19a. When the butterfly shaped cam 15 is coupled to the handle through the coupler 13, either direction of handle rotation causes the slider crank 19 to be moved to the right due to the butterfly shaped cam 15 dual lobe symmetry. The slider crank 19 has a slot 20 that receives a pin 21 from an output shaft 22. Translation of the slider crank 19 causes clockwise rotation of the output shaft 22. The output shaft 22 couples to a dead latch through a tailpiece inserted into its inner cross shape. As with the dead bolt version, a small magnet in the output shaft 22 helps hold the tailpiece in place during assembly. Furthermore, a user can insert a straight blade screwdriver into the cross and rotate clockwise against the two compression springs until the output shaft 22 goes “over center” and the pin 21 ends up on the opposite side of the slider crank 19 slot 20 as shown in FIG. 10.

In this case, translation of the slider crank 19 causes counterclockwise rotation of the output shaft 22. In this way, the unit can be quickly and easily adjustably rehanded for right or left hand doors. Besides being an assisting feature for insert, this provides cost and logistics advantages to have one configuration work for either handling requirement.

As illustrated above, the deadbolt and dead latch versions share most parts and only differ in the last several parts in their respective mechanism chains. The relatively small differences are adapted to by the different output motion requirements. However, sharing of most components has a positive effect on keeping cost and complexity down.

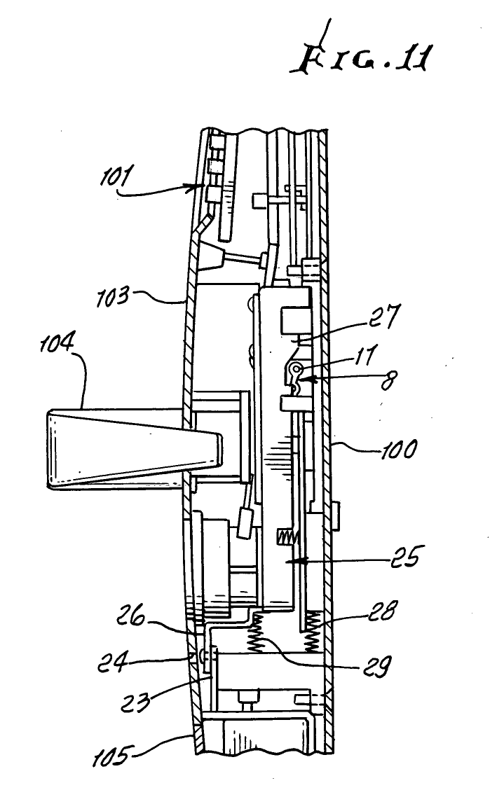

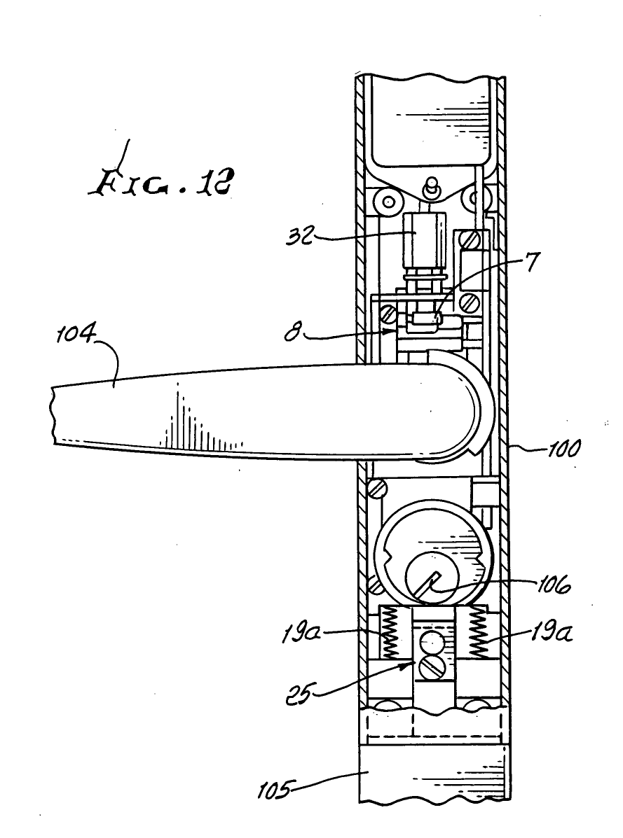

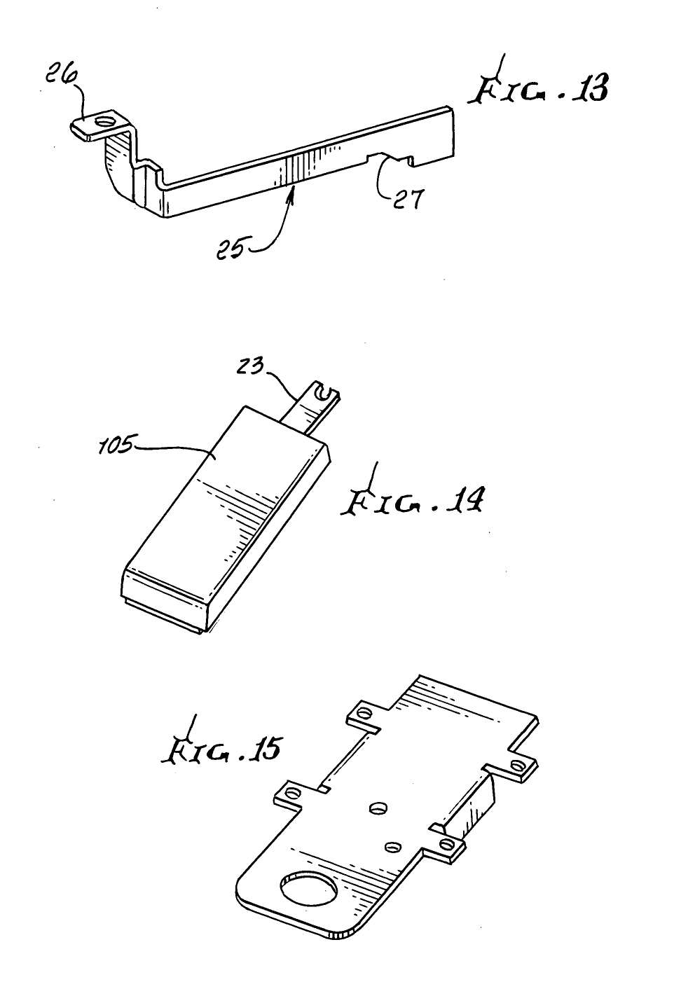

As will all locks, security is of utmost concern. The present device has a battery lid 105 that allows access to the battery compartment. This compartment also allow access to two mounting screws at the bottom of the unit. With these screws removed, the unit can be unclipped from a hook that holds the top of the unit secured to the door. By using such method of securing the unit to a door, all fasteners are hidden. For many architects, this is an important feature. It is therefore of importance that access to the battery compartment be controlled to maintain security. The battery lid has a sheet metal tang that is screwed to the unit base. Access to this screw is provided by a small hole 24 in the top of the unit. Referring to FIG. 11, override bracket 25 has a feature 26 that blocks access to the battery lid 105 screws through this small hole 24. The override bracket 25 interacts with the unit cylinder cam. Rotating the key to an unlocked position accomplishes two things: 1) a cam surface 27 on the back of the override bracket pushes down on the cam follower pin 11 of the cam follower assembly coupling the handle to output and allowing access. 2) The override bracket 25 moves lengthwise to a position where it no longer blocks the battery lid screw and thus allows the battery lid to be removed. If a person were to insert a small sharp object such as a pick into the battery access hole 24 he might use two picks to try and “walk” the override bracket 25 down in small increments eventually allowing access to the battery lid screw and compromising security.

The override bracket 25 is normally biased upward towards the top and front of the unit by two compression springs 28, 29. A small protruding feature 30 on the crank cover 31 normally (such as when someone is using key) does not interact with the override bracket 25. However, when someone necessarily pushes down on the override bracket 25 through the battery lid 23 access hole 24 to “pick” the unit, override bracket 25 moves down slightly until it gets “snagged” by protruding feature 30 on crank cover 31. See also FIG. 15. This prevents to override bracket from being “walked” down to allow access to battery lid 23 screw.

Accordingly, the apparatus is configured to include a battery compartment lid having a retention fastener, an override bracket blocking access to the fastener from the exterior, and having a position in which such access is unblocked, there being means blocking movement of the bracket to said position in response to unauthorized such access.

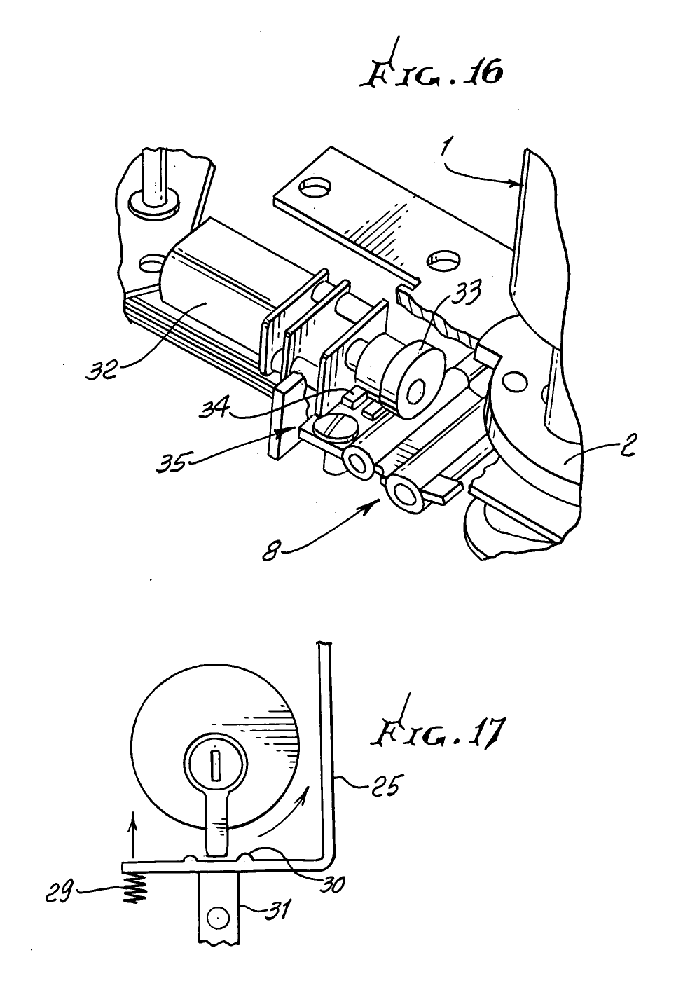

Hall Effect cam position sensing is also provided. See FIG. 16. A gear motor 32 drives a cam 33. The cam 33 has a “high” lobe and a “low” lobe. The high lobe pushes the cam follower assembly 8 down, which couples handle to output. With the cam “low” lobe down, the handle is not coupled to the output. It is therefore important to control the position of the cam 33 such that either the “high” or “low” lobe is down and gear motor 32 does not stop in a position of flux. The cam houses two magnets 34 that interact with a Hall Effect unit 35. The Hall Effect unit senses the magnetic flux of the magnets and “communicates” with microprocessor 80 such that motor starting and stopping position can be correctly controlled.

The Hall Effect unit is powered via an I/O port of the microprocessor.

I claim:

1. Door lock apparatus, comprising in combination:
a) an elongated housing having input code selectors on the housing, to enable door locking and/or unlocking via a locking element,
b) a locking handle protruding from the housing,
c) a coupling in the housing having parts that interfit to enable force transmission between said handle and element,
d) and first means responsive to code selection to control coupling of said parts.

2. The combination of claim 1 wherein said means includes an electronic motor in the housing to effect controlled displacement of one or more of said parts.

3. The combination of claim 2 including second means to compensate for interfit misalignment of said parts and to automatically overcome said misalignment.

4. The combination of claim 3 wherein said second means includes a spring or springs biasing at least one of said parts to interfit another of said parts in response to relative rotation of said parts.

5. The combination of claim 4 wherein said parts include pins, and slots to receive said pins to effect the coupling.

6. The combination of claim 5 wherein one of said springs is a compliant fork-shaped leaf spring urging the coupling against tips of the pins.

7. The combination of claim 1 including second means in the housing to allow handle excess force transmission decoupling, for handle re-positioning relative to the housing.

8. The combination of claim 1 wherein said first means includes a shaft turnable by the handle, and detent components that resist handle turning at selected handle turn angles, and also allow handle turning in response to override force transmitted via handle turning, for handle re-positioning relative to the housing.

9. The combination of claim 1 including handle transmission force resisting structure that includes a rotor, an elongated spring, and at least one set of interengaged balls that transmit spring force to the rotor with mechanical advantage.

10. The combination of claim 1 including means to compensate and overcome misalignment of coupling pins and slots in a coupler.

11. The combination of claim 2 including a leaf spring and a compliant forked member in the coupled chain between the motor and the coupling.

12. The combination of claim 1 including means to allow release of a battery cover, including a one-piece elongated shifter movable in response to key input turning of a keeper rotor.

13. The combination of claim 1 including a Hall Effect unit driving a cam having “high” and “low” side lobes engageable with a cam follower assembly controlling coupling of handle to output, the cam having magnets whose flux is sensed by the Hall Effect unit for controlling a processor that in turn controls a motor driving the coupling.

14. The combination of claim 1 wherein the housing includes a battery compartment lid having a retention fastener, an override bracket blocking access to the fastener from the exterior, and having a position in which such access is unblocked, there being means blocking movement of the bracket to said position in response to unauthorized such access.

15. The combination of claim 14 wherein said first means includes a shaft turnable by the handle, and detent components that resist handle turning at selected handle turn angles, and also allow handle turning in response to override force transmitted via handle turning, for handle re-positioning relative to the housing.

16. The combination of claim 15 including handle transmission force resisting structure that includes a rotor, an elongated spring, and at least one set of interengaged balls that transmit spring force to the rotor with mechanical advantage.

17. The combination of claim 8 including handle transmission force resisting structure that includes a rotor, an elongated spring, and at least one set of interengaged balls that transmit spring force to the rotor with mechanical advantage.

18. The combination of claim 7 whereas said first means includes a shaft turnable by the handle, and detent components that resist handle turning at selected handle turn angles, and also allow handle turning in response to override force transmitted via handle turning, for handle re-positioning relative to the housing.

19. The combination of claim 13 wherein said first means includes a shaft turnable by the handle, and detent components that resist handle turning at selected handle turn angles, and also allow handle turning in response to override force transmitted via handle turning, for handle re-positioning relative to the housing.

20. The combination of claim 3 wherein said first means includes a shaft turnable by the handle, and detent components that resist handle turning at selected handle turn angles, and also allow handle turning in response to override force transmitted via handle turning, for handle re-positioning relative to the housing.
